(19) United States
(12) Patent Application Publication
(10) Pub. No.: US 2003/0104346 A1
(43) Pub. Date: Jun. 5, 2003

(54) Waterproof lyrics display

(76) Inventor: David Stein, New York, NY (US)

Correspondence Address: George Gottlieb Esq., c/o Gottlieb, Rackman & Reisman, P.C., 270 Madison Avenue, New York, NY, 10016, US

(21) Appl. No.: 09/998,618

(22) Filed: Nov. 30, 2001

(51) Int. Cl. G09B 29/00

(52) U.S. Cl. 434/430

(57) ABSTRACT

This invention aids singing in the shower. A preferred embodiement is a waterproof book of song lyrics which when wetted adheres to the shower wall. For best adhesion, the book has the slim proportions of a magazine or pamphlet. It is easily moveable on the wall for people of different heights. Its large font sizes are easy to read in shadowy light and streaming water. For thicker books, additional support by suction cups or brackets can be provided. Also disclosed are waterproof posters adhering wet to the shower wall and displaying lyrics, photos of musicians, or other art. A series of waterproof lyrics collections (CDs possibly included) would offer singers in the shower all the best of popular song.

This invention aids singing in the shower. A preferred embodiement is a waterproof book of song lyrics which when wetted adheres to the shower wall. For best adhesion, the book has the slim proportions of a magazine (eg. 8.5″×11″×¼″) or pamphlet (eg. 5.5″×8.5″×1/16″). It is flexibly bound so its wet pages adhere flat to the wall and one another. It is easily moveable on the wall for eye-level viewing by children or adults of different heights. Its large (eg. 18-point) font sizes are easy to read in shadowy light and streaming water. For thicker books, additional support by suction cups or brackets can be provided. Also disclosed are waterproof posters adhering wet to the shower wall and displaying lyrics, photos of musicians, or other art. A series of waterproof lyrics collections (CDs possibly included) would offer singers in the shower all the best of popular song.

### OBJECTS AND DEFINITIONS

A first object of this invention is to aid singing in the shower by providing a waterproof lyrics display readily attachable on the shower wall.

A second object is that said display be readily detachable, both display and wall remaining intact.

A third object is that said display be easily moveable on the wall, for eye-level viewing by children or adults of different heights standing in the shower.

A fourth object is that said display be easy to read in shadowy light and streaming water—without glasses. This requires large font sizes on large pages, with lyrics flat to the wall and horizontal.

A fifth object is that said display be simple, beautiful, inexpensive, and almost self-explanatory in use.

As used herein: waterproof means unharmed by water; lyrics means any text intended to be sung, as shown by existence of a musical score or recording; lyrics display means lyrics and support means; shower enclosure means the vertical surfaces surrounding a shower head; to shower means to stand under a shower head; and water adhesion means adherence of two surfaces when wet.

### PRIOR ART

Seventeen percent of Americans, about 40,000,000 people, sing in the shower (American Standard Co. survey, 1999). However, as folksinger Pete Seeger has pointed out, the average singer knows many song melodies, but few of the lyrics. An aid enabling singers in the shower to learn all the lyrics of popular songs might therefore sell millions of copies—and help singers everywhere. Despite this potential, no prior art has been found disclosing a waterproof lyrics display readily attachable to a shower wall and especially adapted for singing in the shower environment.

Waterproof books for reading in the bathtub (novels, stories, nonfiction) have long been marketed. But the bathtub, aside from its cleansing function, is very different from the shower. People relax in the bathtub, sitting, lying down, soaking. Reading there is quiet, introverted—physically and psychologically the opposite of actively standing up singing. And, as detailed below, books designed for the bathtub are completely wrong for the shower.

Typical of bathtub books, the waterproof story collection “Aqua Erotica” from Random House (© 2000 Melcher Media, New York, N.Y.), has a blocky shape (4.6″×7″×¾″). This contrasts with our preferred slim magazine or pamphlet. No means of attaching the heavy book to a shower wall is provided, and the stiff binding prevents the open book from flattening back. Not least, the tiny 9-point font is almost illegible in the shadowy light and downpour of a shower.

Light behind a closed shower curtain can be much darker than in the open bathtub. Any shower curtain, transparent or opaque, casts a shadow. Downpouring water and the person showering cast shadows. Also, people who wear glasses—reading in the bathtub with them—seldom wear them in the shower. All this, and water running in the eyes, makes design for legibility—large fonts on large pages at eye level—more critical in the shower.

“Thomas the Tank Engine Visits a Farm”, also from Random House (© 1991 William Heinemann Ltd.), represents a type of bathtub book for young children. Again, the shape is blocky (4.5″×4.5″×1″). The pages, foam-filled so the book will float, are too thick and costly for a book of any length. No means of attaching to a wall is provided. Not least, the small pages could not display lyrics in large font without always breaking lyrical lines—and the song into several pages. Such breaks—harmless to ordinary reading where one can double back at leisure—should be avoided with song, which moves constantly forward.

Several patents, eg. Bathing Caddy U.S. Pat. No. 5,761,753 by Talbert, and Bathtub Book Holding Device U.S. Pat. No. 5,707,036 by Dunbar, show mechanisms for supporting a book in the bathtub. These complex devices differ from the present invention. They are not meant to aid singing in the shower. If installed at eye level in the shower enclosure, they would obstruct showering and create a hazard.

Another patent, Note Pad Product For Use In Shower Or Bath U.S. Pat. No. 5,137,453 by Hudson, provides an erasable blank surface with suction cups in back. This is not meant to aid in singing. The singer would first have to write the lyrics on the surface, a laborious inconvenience. What's worse, writing a second set of lyrics would require erasing the first ones.

A waterproof CD player that hooks on a shower head is offered by Sharper Image of San Francisco (catalog item S1538). A songbook hooked thus would be vertically immoveable—above eye level of many. It would be hard to read even if slung lower, because this tends to be the darkest area of the shower. (Economical plumbing usually locates the vanity and shower head on the same wall. The vanity light, often the only illumination, shines obliquely past, leaving the shower head wall in relative darkness.) Finally, the shower head downpour obstructs reading here. Attempts to peer around, with spray in one's eyes, or to duck through—which floods the eyes entirely—are soon abandoned.

Regarding papers, the ordinary fibrous kind is unsuitable for this invention. Not being waterproof, such papers wrinkle and blister when flattened wet to a wall. The adhesive moisture then quickly evaporates through the fibrous pores, and the papers fall. Fortunately, waterproof papers inexpensive enough for songbooks have recently been developed. When wetted, these papers will adhere to a shower wall almost indefinitely.

In sum, no discovered prior art provides waterproof lyrics to aid singing in the shower. None provides a waterproof lyrics display moveably attachable by water adhesion or suction cups to a shower wall and especially adapted for easy legibility in shadowy light and streaming water.

### FIGURES OF THE DRAWINGS

All the drawings show a waterproof lyrics display attached to a shower wall.

FIG. 1A and its cross-section FIG. 1B show a songbook supported by water adhesion.

FIGS. 2 and 3 show two alternate songbooks with holes therein supported by suction cups.

FIG. 4A shows a cross-section through a suction cup of FIG. 2. FIGS. 4B and 4C show cross-sections through two alternate types of suction cups for supporting heavier songbooks.

FIG. 5 and its cross-section FIG. 6 show a songbook supported by a suction cup bracket.

FIGS. 7A and its cross-section FIG. 7B show waterproof posters supported by water adhesion.

### DETAILED DESCRIPTION OF THE DRAWINGS

All the drawings show a conventional shower enclosure surface of bathroom tiles 10 having tile joints 11. Besides tile, any smooth shower enclosure material (glass, fibreglass, enamel, vinyl, etc.) can support the displays disclosed.

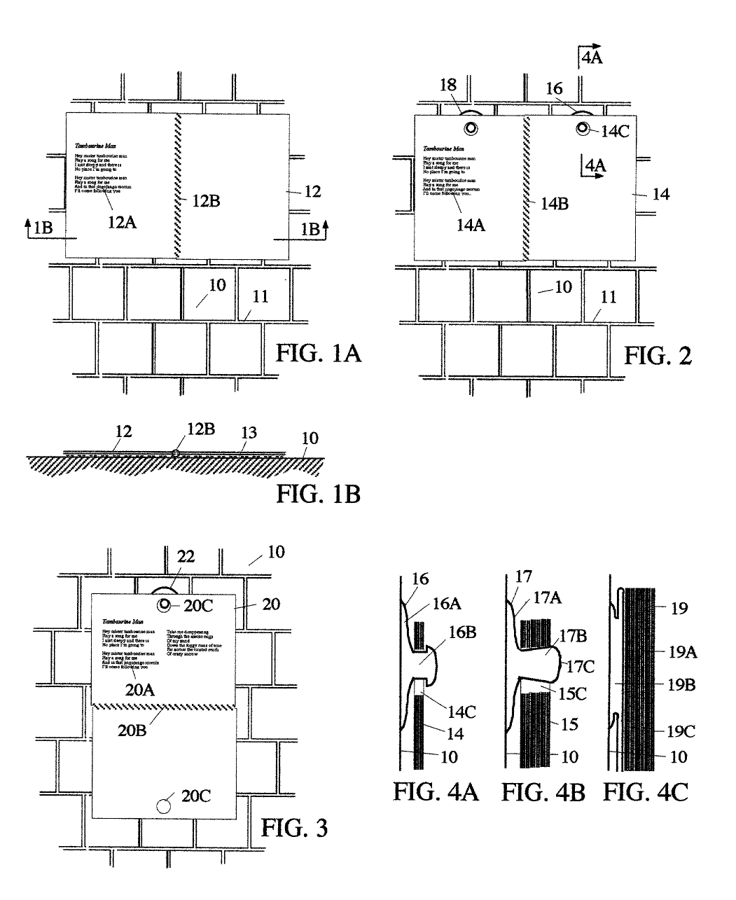

FIGS. 1A and 1B illustrate support by water adhesion. A thin film of water 13 (shown dotted) supports songbook 12 having text 12A and flexible binding 12B on enclosure surface 10. The support method comprises wetting the book, thereby creating water film 13, and pressing the book to the surface. The book adheres stationary on the surface, but is controllably moveable, sliding up or down as desired for different eye-levels.

A book having the slim proportions of a magazine (eg. 8.5″×11″×¼″) adheres best. The magazine-size page can display the entire lyrics of a 5-minute song in fonts large enough (eg. 18-point) for easy reading in the shower. A long series of waterproof anthologies—American Favorites, Folksongs, Blues, Christmas Carols, Louis Armstrong, Beatles, Bob Dylan, Pete Seeger, Billie Holiday, Frank Sinatra, Elvis Presley—and so on through the latest rave—could be published for singing in the shower. Photos of musicians and other art—covers, centerfolds, foldouts, etc.—would brighten the shower enclosure.

CD recordings could be packaged with these songbooks (eg. attached in a protective sleeve). CDs would be removed before installing the songbook in the shower.

A waterproof pamphlet (eg. 5.5″×8.5″×1/16″) containing one CD is another preferred form. A dozen such pages could display in large font (eg. 18-point) the lyrics of almost any CD, with room to spare for art. A few vivid pages of photographs could celebrate the musicians even more expansively than LP album covers of earlier days. In effect, these pamphlets would become a new, extroverted, more expressive style of CD package. Replacing the tiny art and fonts of the little plastic box, they would invite singing—in the shower or out.

The pages of songbook 12 are desirably of waterproof paper or plastic, but other materials (eg. laminated paper) are possible.

Binding 12B must let book 12 adhere flat to the wall. A conventional plastic spiral binding is preferred for the magazine format. Saddle staples are flexible and water-resistant enough for the CD pamphlets. Waterproof thread, rings, glue, etc. are other possibilities.

In FIG. 2, another songbook 14 has holes 14C which engage suction cups 16 and 18 for support.

Holes 14C are pierced through songbook 14 at top and center of each page. This way, text 14A hangs horizontal, regardless whether the book is open or closed, or how turning of pages distributes the weight. For pages to turn easily, holes 14C must be large enough to engage the projections of the suction cups loosely.

To adhere properly, suction cups 16 and 18 must not overlap joints 11 between modular tiles 10. Standard tiles in the U.S. usually measure 4″ or 6″ wide. To avoid joints, the suction cups in FIG. 2 should be located 8.5 to 9.5 inches apart, and have a diameter at the wall surface of 2.5″ or less. It happens that a loosely bound 8.5″×11″ book, with holes punched top and center, spaces two suction cups perfectly.

The method of hanging book 14 comprises: pressing suction cup 16 to enclosure surface 10; hanging book 14 thereon by holes 14C; opening the book side to side, whereby holes 14C locate second suction cup 18; and pressing cup 18 to the wall so that holes 14C are loose around both supports and the pages turn easily.

In FIG. 3, another waterproof songbook 20 has lyrics 20A, binding 20B, and holes 20C pierced opposite the binding. The book hangs from at least one suction cup 22 and opens vertically with the binding horizontal. This book format has the advantage of allowing two large-font columns of lyrics per page, with few confusing line breaks.

In FIG. 4A (a cross-section of FIG. 2), suction cup 16 is item SC250P from Suction Cups Inc. of Greenpoint, N.Y. (January, 2001 brochure). Cup 16 adheres to wall surface 10, has suction portion 16A, projecting peg portion 16B, and supports book 14 by engaging holes 14C. This suction cup will support a songbook less than ⅛″ thick, and the pages will turn easily provided holes 14C are large relative to the peg.

FIG. 4B shows a new suction cup 17 designed for supporting a thicker book 15 by holes 15C. Suction portion 17A is molded integrally with projecting peg portion 17B, whose length supports all pages of book 15, and whose top slants slightly upward towards a rounded end 17C. In this design, all pages are supported and retained, yet are easily disengaged for turning.

FIG. 4C shows a thick songbook 19 having pages 19A, and at least one suction cup 19B integral to book cover 19C. Suction cups and cover might be molded of one piece in transparent vinyl or other suitable material. Or the book cover could be a plain flat sheet attached to wall 10 by a double-sided suction cup (eg. item QR-40, brochure cited above).

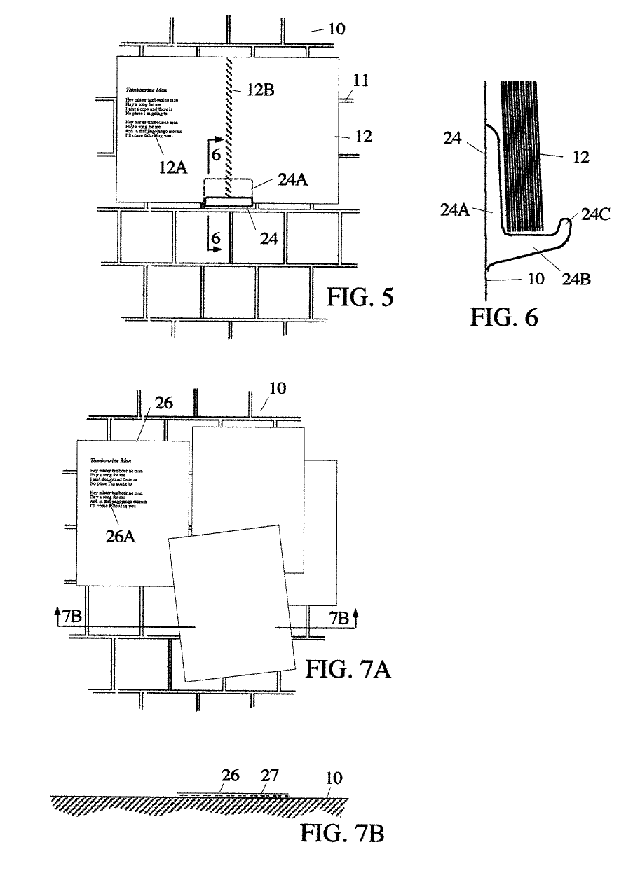

In FIGS. 5 and 6, a bracket 24 having rectangular suction cup portion 24A, ledge portion 24B, and lip portion 24C supports book 12 on wall surface 10. The bracket is preferably plastic or rubber, molded of a piece less than 4″ long (to avoid joints 11), and is easily moveable on the wall. Other designs using one or more circular suction cups are possible.

In all the disclosed support means involving suction cups or brackets, water adhesion still plays a part, holding the book flat to the wall, and pages to each other.

In FIGS. 7A and 7B, waterproof posters 26 are wetted by water film 27 (shown dotted), whereby they adhere to the shower enclosure and to each other. The posters will also adhere to a shower curtain—as will the magazines and pamphlets previously disclosed. The posters can be of any size and very colorful, some displaying lyrics 26A, others displaying photos of musicians or other art. A collection of such posters could transform the shower enclosure into a vivid collage of one's favorite artists.

In addition to the above disclosure, I mean to cover in my claims any alternative details and variations that reasonably fall within the scope of this application.

1. To aid singing in a shower enclosure, a waterproof lyrics display comprising: at least one page of song lyrics, said page being waterproof; and support means for supporting said page and being readily attachable to a vertical surface of the shower enclosure, so as to support said page at eye level of a person standing in the shower enclosure.

2. The display of claim 1 wherein there are multiple pages of song lyrics.

3. The display of claim 1 wherein the support means is readily moveable and attachable at different locations and heights in the shower enclosure.

4. The display of claim 1 wherein the support means comprises a thin layer of water, located between the page and the shower enclosure, attaching the page to the enclosure by water adhesion.

5. The display of claim 2 wherein the multiple pages comprise a book with a book cover, and said book has a flexible binding enabling the pages to flatten closely against the shower enclosure.

6. The display of claim 5 further comprising at least one CD recording, and means detachably attaching the recording to the book.

7. The display of claim 5 wherein the support means comprises at least one suction cup.

8. The display of claim 7 wherein said suction cup engages holes in said pages, said holes being positioned so the pages hang with said lyrics substantially horizontal, and said holes being sufficiently large to enable easy turning of pages.

9. The display of claim 8 wherein there are two suction cups fixed at equal height on the shower enclosure, and wherein said holes pierce all said pages and cover, and wherein turning of said pages disengages them from one suction cup and engages them with the other.

10. The display of claim 9 wherein said two suction cups have a diameter measured at the shower enclosure surface, and a distance apart center-to-center such that said cups can be positioned on the surface without overlapping any joints in commonly found patterns of modular bathroom tile.

11. The display of claim 10 wherein said diameter measured at the enclosure surface is 2.5 inches or less, and said distance apart is 8.5 to 9.5 inches.

12. The display of claim 8 wherein said holes are pierced in said book on the side opposite said binding, and said book when supported on said vertical surface has its binding horizontal and opens vertically.

13. The display of claim 2 wherein said support means comprises a bracket fixed to a surface of said shower enclosure.

14. The display of claim 13 wherein said bracket includes a suction cup portion and is easily moveable on the shower enclosure to eye levels of people of varying height.

15. The display of claim 5 wherein the support means comprises a thin layer of water, located between the book and the shower enclosure, attaching the book to the enclosure by water adhesion.

16. The display of claim 5 wherein the pages when wetted adhere to one another by water adhesion.

17. The display of claim 5 wherein the support means comprises water adhesion and at least one suction cup.

18. The display of claim 1 wherein the vertical surface is a shower curtain, and the support means is water adhesion.

19. The display of claim 8 wherein said suction cup has a projecting peg portion having a length, a top, and a rounded end, said length being sufficient to pass through said holes supporting the pages of said book, and said top slanting slightly upwards towards said rounded end, whereby all pages of said book can be supported and retained, yet are easily disengaged for turning.

20. A method of locating the suction cups of claim 9, comprising: fixing one suction cup to said surface; hanging said book thereon; and opening said book, whereby said holes locate the second suction cup.

21. The display of claim 14 wherein the bracket and suction cup are molded of a single material 4 inches long or less.

22. The display of claim 7 wherein the suction cup is integral to the book cover and attaches the cover to the shower enclosure.

23. The display of claim 7 wherein the suction cup is double-sided and attaches the book cover to the shower enclosure.

24. The display of claim 5 wherein the book has slim proportions and a cover area sufficently large to enable support of the book on a shower wall by water adhesion.

25. The display of claim 24 wherein the proportions fall between those of 8.5″×11″×¼″ and 5.5″×8.5′×1/16″.

26. The display of claim 24 wherein the cover measures at least 8.5″×11″.

27. The display of claim 1 wherein the lyrics are printed in sufficently large font to enable easy reading at eye level on a shower wall in downpouring water behind a closed shower curtain.

28. The display of claim 27 wherein the page is sufficently large to display the entire song with no breaks in lyrical lines.

29. The display of claim 27 wherein the font size of the lyrics is 18-points or greater, and the page size is 8.5″×5.5″ or greater.

30. The display of claim 2 wherein the support means comprises at least one suction cup.

31. The display of claim 2 wherein the support means comprises water adhesion and at least one bracket.

32. A method of supporting a waterproof page of song lyrics on a shower enclosure surface, said method comprising the steps of wetting said page, and flattening it to said surface.

33. A method of supporting a waterproof poster on a shower enclosure surface, said method comprising the steps of wetting said poster, and flattening it to said surface.

34. A method of aiding singing in a shower enclosure, comprising:
(a) providing a waterproof book of song lyrics;
(b) wetting said book;
(c) applying a wet surface of said book to the shower enclosure at a location where a person can readily view the lyrics.

35. A method of aiding singing in a shower enclosure, comprising:
(a) providing at least one page of waterproof song lyrics;
(b) supporting said lyrics on a shower enclosure surface at eye level of a person singing.

36. A method of aiding singing in a shower enclosure, comprising:
(a) providing a waterproof book of song lyrics;
(b) attaching said book to a shower enclosure surface by means of at least one suction cup.
